(19) United States
(12) Patent Application Publication
(10) Pub. No.: US 2021/0066988 A1
(43) Pub. Date: Mar. 4, 2021

(54) ELECTRICAL CONNECTION DEVICE FOR ROTATING ELECTRICAL MACHINE

(71) Applicant: VALEO EQUIPEMENTS ELECTRIQUES MOTEUR, Creteil (FR)

(72) Inventors: Virginie Leroy, Creteil (FR); Michaël Hanquez, Creteil (FR)

(21) Appl. No.: 16/982,799

(22) PCT Filed: Mar. 22, 2019
(86) PCT No.: PCT/EP2019/057308

§ 371 Date: Sep. 21, 2020

(30) Foreign Application Priority Data
Mar. 23, 2018 (FR) 1852508

(51) Int. Cl. H02K 3/52; H02K 5/22; H02K 3/28

(52) U.S. Cl. CPC H02K 3/522; H02K 2203/09; H02K 3/28; H02K 5/225

(57) ABSTRACT

One aspect of the invention relates to an electrical connection device comprising: an internal connection member surrounding an axis X having a plot, and a plurality of connectors; a first external connection member surrounding the axis X and being stacked axially with the internal connection member, comprising a plot, and a plurality of connectors; the device being characterized in that each plot has a wavy shape forming troughs comprising internal troughs situated facing the axis X and external troughs situated on an external periphery, each connector of the internal connection member being connected in an internal trough of the plot of the internal connection member and each connector of the first external connection member being electrically connected in an external trough of the plot of the first external connection member.

### CROSS-REFERENCE TO RELATED APPLICATIONS

This application is a National Stage application of International Patent Application No. PCT/EP2019/057308, filed on Mar. 22, 2019, which claims priority to French Patent Application No. 1852508 filed on Mar. 23, 2018, each of which is hereby incorporated by reference in its entirety.

### TECHNICAL FIELD

The technical field of the invention is that of rotating electrical machines such as motors, alternators and alternator-starters.

The present invention relates to an electrical connection device for rotating electrical machines. The present invention also relates to a corresponding rotating electrical machine. The invention finds a particularly advantageous application in the field of alternator-starters used in so-called “hybrid” systems configured to participate in the propulsion of hybrid vehicles. These systems comprise for this purpose a heat engine mechanically driving in rotation the electrical machine in alternator mode configured to supply, when it is necessary, electrical energy to supply batteries or instead the electrical machine may, in motor mode, participate in the propulsion of the vehicle.

### BACKGROUND

Rotating electrical machines comprising a stator and a rotor integral with a shaft are known wherein each coil present on the stator is connected to a current source by electrical cables constituted of a conductive material such as copper often surrounded by an insulating shell.

For a three-phase motor comprising three phases U, V and W, it is known to use an electrical cable with three wires delivering a three-phase current then, through a star or triangle coupling, to connect each coil or each series of coils by a cable to the corresponding phase. Thus, the first coil, or series of coils, will be connected to the phase U, the second coil, or series of coils, to the phase V and the third coil, or series of coils, to the phase W.

These systems have the drawback of having to connect, using electrical cables, all the coils of the stator, which creates bulk. This bulk makes difficult soldering operations which normally consist in “V-shaped” solders made on each connector. The mounting then constitutes a step which is long and which generates errors. In addition, these systems do not enable standardisation of the conductive and insulating elements.

Rigid electrical connection systems of annular shape are known, such as described in the US patent application No US 2008/0150377 (A1), which comprise connections to the coils on the external periphery only or, such as described in the European patent application No EP 2 677 634 (A1), which comprises connections on the internal periphery only. These electrical connection systems comprise four conductive rings stacked axially one on the other and insulated from each other. Three of these rings are configured to be connected to the three phases U, V and W of the rotating electrical machine and a fourth ring is configured to be connected to the neutral of the machine. These electrical systems are configured to connect a rotating electrical machine to the electrical supply by a so-called star coupling. These systems do not enable other types of couplings to be put in place and have considerable bulk due to the multiple connections arranged exclusively on a periphery of the system. These systems are composed of an assembly of dissimilar parts and consequently do not enable standardisation either.

The French patent FR 3 035 554 proposes an electrical connection system comprising, as in the solutions described previously, several conductive rings stacked axially one on the other and insulated from each other but each ring is composed of two conductive elements, a first conductive element arranged at the exterior periphery of the ring and having connectors extending projecting towards the exterior of the ring and a second conductive element arranged at the interior periphery of the ring and having connectors extending projecting towards the interior of the ring. Thus, the connections are arranged on the two peripheries of the system which contributes to reducing the bulk and the risk of electrical proximity compared to the previously described solutions while enabling direct control of the phases of a rotating electrical machine, notably using a double bridge inverter.

However, the fact of having connections on the exterior periphery and the interior periphery necessitates reducing the surface of the ring in the radial plane which leads to an increase in the resistance and thus a reduction in the current in the ring configured to supply the coils in motor mode or to receive by the coils in alternator mode, leading to risks of malfunction and heating by Joule effect. The ring then dissipates the heat less well, which leads to risks of overheating.

None of the present systems makes it possible to respond simultaneously to all of the required needs, namely to enable direct control of the electrical phases of a rotating electrical machine with reduced bulk while minimising the risks of overheating and malfunction.

### SUMMARY

The invention offers a solution to the aforementioned problems, by proposing an electrical connection device capable of controlling the phases of a rotating electrical machine and making it possible to avoid malfunctions and overheating while have a small bulk.

A first aspect of the invention relates to an electrical connection device comprising:
an internal connection member surrounding an axis X comprising a track, an insulating shell covering at least one radial surface of the track and a plurality of connectors capable of conducting an electrical current electrically connected to the track; and
a first external connection member surrounding the axis X and being stacked axially with the internal connection member, the first external connection member comprising a track, an insulating shell covering at least one radial surface of the track and a plurality of connectors electrically connected to the track;
the device being characterised in that each track has an undulated shape forming troughs and peaks in the radial plane, the troughs comprising internal troughs situated opposite the axis X and external troughs situated on an external periphery of the track, each connector of the internal connection member being electrically connected in an internal trough of the track of the internal connection member and each connector of the first external connection member being electrically connected in an external trough of the track of the first external connection member.

Thanks to the invention, the device can establish an electrical connection with at least one coil of which the input could be connected to the track of the external connection member and the output to the track of the internal connection member of which the connections are made by means of connectors situated at the external periphery and at the internal periphery of the device, which reduces the radial and/or axial bulk. The undulated shape of the tracks further makes it possible to have rings with radial surfaces minimising the risks of malfunction and overheating, by exploiting the troughs, by placing the connectors therein. The connectors are thus sufficiently far apart, because separated by a peak, without the radial surface of the tracks having had to be reduced, while optimising the bulk.

Apart from the characteristics that have been mentioned in the preceding paragraph, the device according to a first aspect of the invention may have one or more complementary characteristics among the following, considered individually or according to all technically possible combinations thereof.

Advantageously, the first external connection member is stacked axially on the internal connection member.

Thus, the first external connection member and the internal connection member are stacked one on the other, on a same side of the stator.

Advantageously, each track has an undulated ring shape.

Thus, the device is adapted to the shape of the stator of a rotating electrical machine.

Advantageously, the tracks are identical.

Thus, the tracks are similar and may then be manufactured in series according to the same industrial process, using the same moulds and tooling.

Advantageously, each insulating shell further covers at least one axial surface of the corresponding track.

Thus, the tracks are electrically insulated from each other but also insulated from the exterior.

Advantageously, a connector comprises a hook or a tongue.

Thus, the connection of a coil with a twisted wire is easier via a hook and the connection of a coil with pin soldering is easier via a tongue.

Advantageously, the hook or the tongue of a connector has an axial offset with respect to the troughs in which the connector is electrically connected. Thus, the hook or the tongue may be located in the troughs of another track which limits the bulk.

Advantageously, the device according to a first embodiment of the first aspect of the invention comprises:
a second external connection member surrounding the axis X and being stacked axially with the first external connection member;
a third external connection member surrounding the axis X and being stacked axially with the second external connection member.

Thus, the device can establish an electrical connection with at least three sets of coils which makes it possible to be used within a rotating electrical machine. In the case of a three-phase stator, the stack of three tracks of the external connection members each forming a phase of the stator makes it possible to realise the three phases of the stator. Advantageously, the second external connection member is stacked axially on the first external connection member and the third external connection member is stacked axially on the second external connection member.

Thus, the three external connection members are stacked one on the other, on a same side of the stator. The internal connection member may in this case be arranged on the other axial side of the stator or on the same axial side of the stator as the three stacked external connection members. In this latter case, for example, the second external connection member is stacked axially on the first external connection member, itself stacked on the internal connection member and the third external connection member is stacked axially on the second external connection member.

Thus, the three external connection members and the internal connection member are stacked one on the other, on a same side of the stator.

Advantageously, the device according to a second embodiment of the first aspect of the invention comprises:
a second internal connection member surrounding the axis X and being stacked axially with the first internal connection member;
a third internal connection member surrounding the axis X and being stacked axially with the second internal connection member.

Thus, the device can establish an electrical connection with at least three sets of coils which makes it possible to be used within a rotating electrical machine. In the case of a three-phase stator, the stack of the three tracks of the internal connection members each forming a phase of the stator makes it possible to realise the three phases of the stator.

Advantageously, the second internal connection member is stacked axially on the first internal connection member and the third internal connection member is stacked axially on the second internal connection member.

Thus, the first, second and third internal connection members are stacked one on the other, on the same side of the stator.

The first external connection member may in this case be arranged on the other axial side of the stator or on the same axial side of the stator as the three internal connection members stacked axially. In this latter case, for example, the second internal connection member is stacked axially on the first internal connection member, itself stacked on the first external connection member and the third internal connection member is stacked axially on the second internal connection member.

Thus, the three internal connection members and the external connection member are stacked one on the other, on a same side of the stator.

According to a third embodiment of this first aspect of the invention, the internal connection member further comprises external connectors each electrically connected in an external trough and in that the external connection member further comprises internal connectors each electrically connected in an internal trough of the track of the internal connection member.

According to an example of this third embodiment, the device comprises a second external connection member or a second internal connection member.

Thus, the device can establish an electrical connection with at least three sets of coils which enables it to be used within a rotating electrical machine. In the case of a triangle coupled three-phase stator, on the stack of the three tracks of the internal and external connection members each forming a connection of two sets of coils to form an electrical phase output of the stator.

Advantageously, the external connection members of the first embodiment of the invention or the internal connection members of the second embodiment are identical.

Thus, the external connection members are similar and may then be manufactured in series according to the same industrial process.

Advantageously, the external or internal connection members, according to the embodiment, are angularly offset from each other in such a way that each connector of an external or internal connection member respectively is located axially opposite the external or internal troughs respectively exempt of connectors of other external or internal connection members respectively.

Thus, the electrical bulk and the risks of malfunction are reduced.

Advantageously, each external or internal connection member according to the embodiment comprises an output connector configured to be connected to an electrical equipment, for example a converter, and the external or internal connection members respectively are arranged one on the other with an angular offset in such a way that the output connectors are spaced apart by said angular offset.

Thus, the connectors of the track of a first external or internal connection member according to the embodiment and the connectors of the track of a second external or internal connection member respectively stacked on the track of the first external or internal connection member respectively are offset in such a way as to space apart the connectors. In this configuration, access to the connectors is facilitated during soldering operations: the physical bulk and the electrical bulk are thus reduced.

A second aspect of the invention relates to a rotating electrical machine, characterised in that it comprises:
an electrical connection device described previously in the first aspect of the invention comprising at least the advantage of having three external or internal connection members according to the embodiment;
a first three-phase electrical member comprising at least a first, a second and a third phase electrical input;
a stator provided with a multi-phase winding comprising at least a first, a second and a third set of coils, each set of coils comprising coils, each coil comprising an input and an output,
and in that the tracks of the first, second and third external or internal connection members are electrically connected respectively to the first, second and third phase electrical inputs and in that the first, second, third sets of coils each comprise at least one corresponding coil electrically connected respectively to the track of the first, second, third external or internal connection member by means of an external or internal connector respectively.

Thus, the device according to the first aspect of the invention may be used within a three-phase rotating electrical machine being able to have a star coupling or a triangle coupling.

According to an example of the first embodiment of the device, the first, second and third sets of coils each comprise at least one corresponding coil having its input electrically connected respectively to the track of the first, second and third external connection members and the output of at least one coil of each set of coils is electrically connected to the track of the internal connection member by means of a connector of the internal connection member.

Thus, the device according to a first aspect of the invention is used within a three-phase rotating electrical machine having a star coupling.

According to an example of the second embodiment of the device, the first, second and third sets of coils each include at least one corresponding coil having its output electrically connected respectively to the track of the first, second and third internal connection members and the input of at least one coil of each set of coils is electrically connected to the track of the external connection member by means of a connector of the external connection member.

Thus, the device according to the first aspect of the invention may be used within a three-phase rotating electrical machine having a star coupling.

According to another example of the third embodiment of the device, the device comprises at least one second external connection member and the two external connection members further comprise connectors electrically connected in an internal trough of the corresponding track and in that the internal connection member further comprises connectors electrically connected in an external trough of the track of the first external connection member and in that the inputs of each coil of the first, second and third set of coils are electrically connected to the connectors in the internal troughs respectively of the track of the first and the second external connection members and the internal connection member and the outputs of each coil of the first, second and third set of coils are electrically connected to the connectors connected in the external trough respectively of the track of the second external connection member, the internal connection member and the first external connection member.

Thus, the device according to the first aspect of the invention is used within a three-phase rotating electrical machine having a triangle coupling.

Input of a coil is taken to mean the end of the conductive cable or wire of the coil the furthest away from the axis of the stator and output of a coil is taken to mean the other end of the conductive cable or wire of the coil the closest to the axis of the stator.

Advantageously, the external connection members and the internal connection member may have several tracks in the same plane to make it possible to connect coils of a set in series.

For example, each track may comprise cutting marks. This enables the tracks to come from a single track cut to form a plurality of tracks.

Advantageously, the input of the coil comprises a portion of cable, parallel to the axis X, situated in the troughs wherein is electrically connected the corresponding connector. Thus, the bulk generated by the electrical cables enabling the connection of the coils to the stator is reduced.

Advantageously, the three-phase electrical member further comprises a converter fulfilling the function of rectifier-inverter, said converter comprising a first, a second and a third port, respectively each electrically connected to the track of the first, second and third external or internal connection member according to the embodiment, by means of respectively the first, second and third phase input.

Advantageously, each of the phase inputs is electrically connected to the corresponding track by means of the output connector of the corresponding external or internal connection member according to the embodiment.

Thus, the use of the converter allows the machine to be made to work in alternator mode with the rectifier function or in alternator mode with the inverter function.

Advantageously, according to the embodiments, the track of the internal or external connection member is electrically connected to the stator.

Thus, the neutral is directly connected to the yoke making it possible to reduce a connection between the electrical connection device and the three-phase electrical member.

Advantageously, the rotating electrical machine according to a second aspect of the invention comprises a rotor comprising an external diameter, the connectors of each track with internal connection being situated at the exterior of the external diameter of the rotor.

Thus, the rotor may be mounted by the two axial sides of the stator and the rotor may be longer axially while overrunning and while being surrounded by the electrical connection device.

Advantageously, the rotating electrical machine according to a second aspect of the invention further comprises a fourth, a fifth and a sixth external or internal connection member stacked axially with the first, second and third external or internal connection member according to the embodiments, and in that it further comprises a second three-phase electrical member electrically connected to the track of the fourth, fifth and sixth external connection member.

Thus, a rotating electrical machine with six electrical phases is obtained.

The invention and the different applications thereof will be better understood on reading the description that follows and by examining the figures that accompany it.

### BRIEF DESCRIPTION OF THE DRAWINGS

The figures are presented for indicative purposes and in no way limit the invention.

FIG. 1a shows a schematic representation of an embodiment of an internal connection member according to a perspective view.

FIG. 1b shows a schematic representation of the internal connection member of FIG. 1a according to an axial view.

FIG. 2a shows a schematic representation of an embodiment of an external connection member according to a perspective view.

FIG. 2b shows a schematic representation of the external connection member of FIG. 2a according to an axial view.

FIG. 3a shows a schematic representation of a device according to an embodiment comprising the internal connection member of FIG. 1a and three external connection members stacked axially according to a perspective view.

FIG. 3b shows a schematic representation of the device according to FIG. 3a according to an axial view.

FIG. 4a shows a schematic representation of a stator and a device according to an embodiment comprising the device of FIG. 3a according to a perspective view.

FIG. 4b shows an enlargement of a portion of the stator and the device of FIG. 4a.

### DETAILED DESCRIPTION

Unless stated otherwise, a same element appearing in the different figures has a single reference.

A first aspect of the invention relates to an electrical connection device configured to be used within a rotating electrical machine with the aim of connecting to the electrical supply system. Rotating electrical machine is taken to mean a machine comprising a stator and a rotor, being able to operate according to at least one of the following two modes: an alternator mode wherein the machine produces electrical energy and a motor mode wherein the machine produces mechanical energy corresponding to a torque.

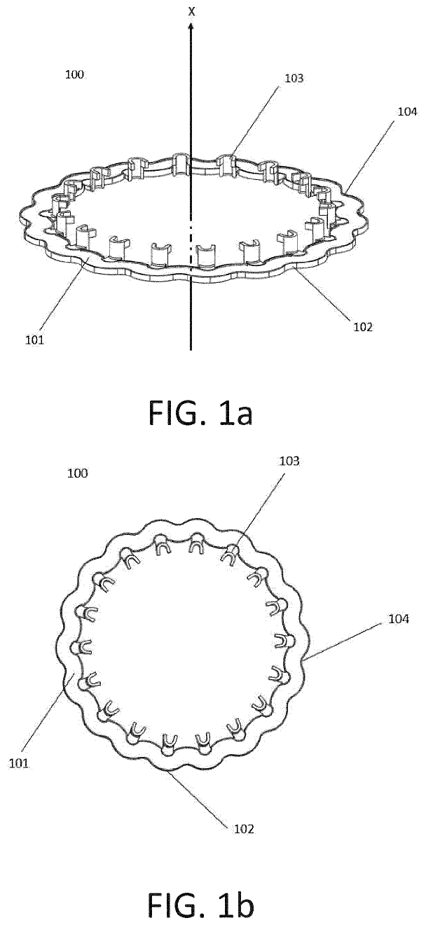

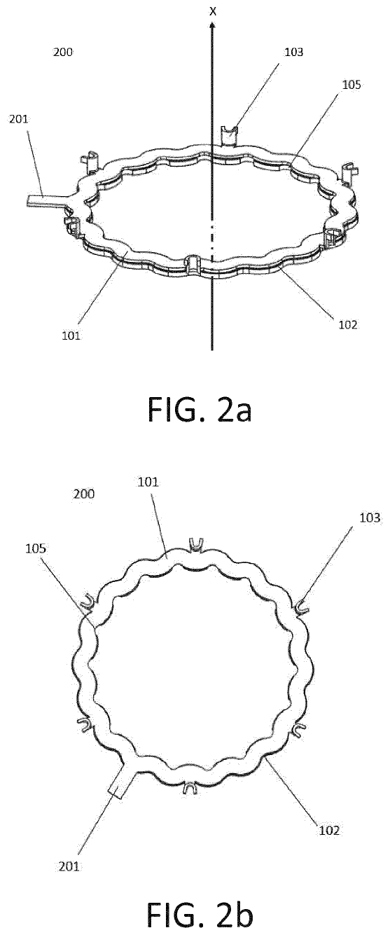

The device according to the first aspect of the invention comprises an internal connection member 100 represented in FIGS. 1a and 1b and a first external connection member 200 represented in FIGS. 2a and 2b.

As represented in FIGS. 1a and 1 b, the internal connection member 100 comprises a track 101 having a ring shape surrounding an axis X. This ring has undulations in its radial plane, having peaks and troughs 104, 105 on its interior periphery, towards the axis X and on its exterior periphery, towards the exterior. In this case, the troughs 104, 105 are identical and the peaks are identical. In the troughs of the interior periphery or internal troughs 105 of the track 101 of the internal connection member 100, connectors 103 are electrically connected to the track 101 of the internal connection member 100.

As represented in FIGS. 2a and 2b, the external connection member 200 comprises a track 101 having an undulated ring shape, surrounding an axis X. In this case, the track 101 of the internal connection member and the track 101 of the external connection member are identical. In the troughs of the external periphery or external troughs 104 of the track 101 of the external connection member 200, connectors 103 are electrically connected to the track 101 of the external connection member 200.

The external connection member 200 is stacked axially with the internal connection member 100 along the axis X, which is not represented in FIGS. 1a, 1b, 2a and 2b. In the present application, a first element is stacked with a second element is taken to mean that the first element and the second element are found in a same stack, as opposed to a first element is stacked on a second element which specifies that the first and second elements are arranged one on the other in a same stack. Thus, within a rotating electrical machine, the external connection member 200 is, for example, separated from the internal connection member 100 by the stator of the rotating electrical machine, that is to say that the external connection member 200 is on one axial side of the stator and that the internal connection member 100 is on the other axial side of the stator.

In this case, the external connection member 200 is stacked on the internal connection member 100. Thus, within a rotating electrical machine, the external connection member 200 and the internal connection member 100 are found on the same side as the stator.

Each track 101 is covered with an insulating shell 102 on at least one of its radial surfaces to enable electrical insulation between the stacked tracks 101. Thus, the track 101 of the internal connection member 100 and the track 101 of the external connection member are each partially covered with an insulating shell 102.

The insulating shell is formed of an insulating material such as, for example a plastic material. The plastic material is, for example, polypropylene more specifically sPP (acronym for syndiotactic polypropylene) or aPP (acronym for alveolar polypropylene). In this case, the insulating shell 102 also covers at least one axial surface of the track 100 enabling its electrical insulation with the exterior. In FIGS. 1a and 1b, the insulating shell 102 covers the whole of an axial surface of the external periphery and partially an axial surface of the internal periphery of the track 101. In particular, the insulating shell covers the part of the peaks of the internal periphery of the track 101.

In FIGS. 2a and 2b, the insulating shell 102 covers the whole of an axial surface of the internal periphery and partially an axial surface of the external periphery of the track 101. In particular, the insulating shell covers the part of the peaks of the external periphery of the track 101.

The tracks 101 are formed of a conductive material. For example, the tracks 101 are formed of a thin plate of copper, steel or aluminium.

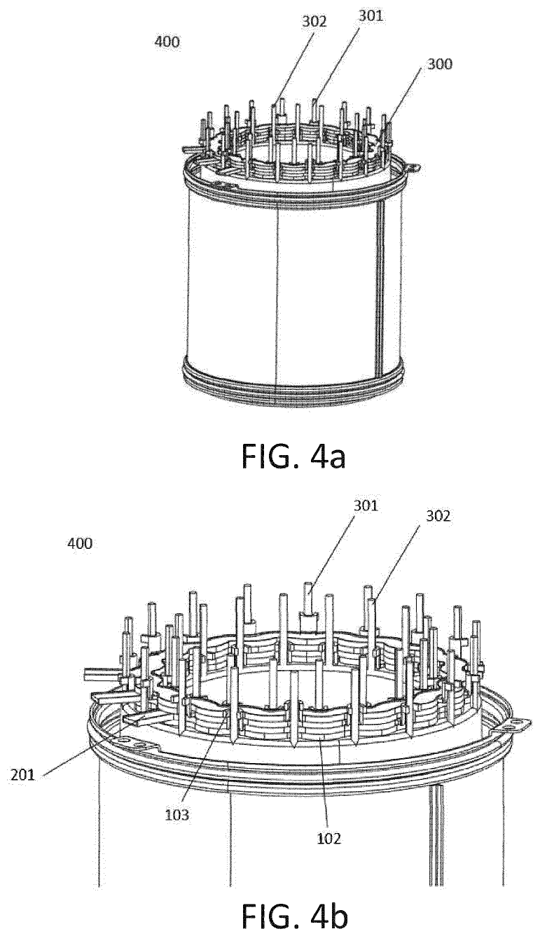

The connectors 103 are for example formed of copper, steel or aluminium. The connectors 103 are configured to be connected to the input 301 or to the output 302 of a coil, as represented in FIGS. 4a and 4b.

The input 301 of a coil and the output 302 of a coil each comprise a portion of cable, a cable comprising at least one electrical wire. In this case, each connector 103 comprises a hook or a tongue, the hook being particularly suited to the case where the cable comprises one or more twisted wires and the tongue to the case where the cable is soldered using pin soldering. The hooks or tongues are for example made of copper, steel or aluminium. In this case, the hooks or tongues are made of the same material as the tracks. In this case, each hook or each tongue of a connector 103 is axially offset with respect to the troughs 104, 105 in which is connected the connector 103. Thus, the connector 103 of a track 101 may be found in the troughs 104, 105 of another track 101.

In this case, each internal trough 105 of the track 101 of the internal connection member 100 is connected to a connector 103, as represented in FIGS. 1a and 1b.

In this case, the external connection member 200 comprises an output connector 201, represented in FIG. 2a. The output connector 201 is of elongated shape oriented to the exterior so as to be able to be connected to an electrical equipment, such as for example a converter or a power supply source.

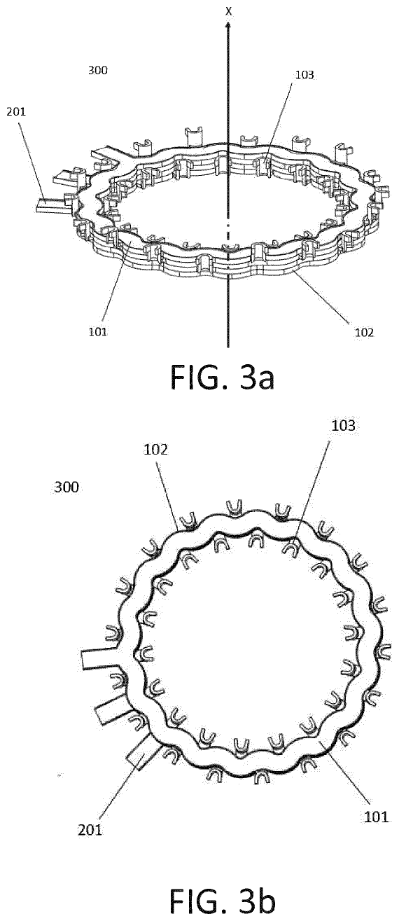

According to an embodiment, a second external connection member 200 is stacked axially with the first external connection member 200, itself stacked with the internal connection member 100 and a third external connection member 200 is stacked axially with the second external connection member 200 to form an electrical connection device 300 represented in FIGS. 3a and 3b.

In this case, the second external connection member 200 is stacked axially on the first external connection member 200 and the third external connection member 200 is stacked axially on the second external connection member 200.

Thus, within a rotating electrical machine, the three external connection members 200 are arranged on a same side of the stator.

In this case, the second external connection member 200 is stacked axially on the first external connection member 200, itself stacked on the internal connection member 100 and the third external connection member 200 is stacked axially on the second external connection member 200.

Thus, within a rotating electrical machine, the three external connection members 200 and the internal connection member 100 are arranged on a same side of the stator.

In this case, the first, second and third external connection members 200 are identical so as to reduce the production costs. In this case, the external connection members 200 are stacked with an angular offset in such a way that their output connectors 201 are spaced apart by said angular offset to facilitate the projection of the output connectors 201. Thus, mounting is facilitated and the risks of electrical interactions between output connectors 201 are reduced. In this case, the external connection members are stacked between them such that the peaks and the troughs 104, 105 of their tracks 101 are aligned.

In this case, the connectors 103 are distributed in such a way that two connectors 103 are not arranged along a same axis parallel to the axis X and that each hook or tongue of a connector 103 can be found in the external trough 104 of another external connection member 200.

Thus, since the device 300 has three external connection members 200, each external connection member 200 has a connector 103 in only one external trough 104 out of three, as represented in FIG. 2a. Each connector 103 is then placed advantageously to be able to be connected to a coil. In this case, the connector 103 of the interior periphery and the connector 103 of the exterior periphery configured to connect a same coil are angularly offset corresponding to a width of coil.

The characteristics of the external connection members 200 are valid whatever the number of external connection members 200 in the electrical connection device. For example, if the electrical connection device comprises five external connection members 200, each external connection member 200 has a connector 103 in only one external trough 104 out of five.

The device 300 may be used in a three-phase rotating electrical machine to enable direct control of the electrical phases of the rotating electrical machine. For this purpose, the rotating electrical machine comprises a three-phase electrical member comprising at least three phase electrical inputs, each being electrically connected to a track 101 of one of the three external connection members 200 in such a way that each track 101 of the device 300 is connected to a different phase electrical input. In this case, the connection between a track 101 of an external connection member 200 and a phase electrical input is made via the output connector 201 of the external connection member 200. In this case, the three-phase electrical member comprises a converter fulfilling the function of rectifier-inverter, comprising three ports, each being connected to a track 101 of one of the three external connection members 200 by means of the corresponding phase electrical input.

The rotating electrical machine also comprises a stator 400. The stator 400, represented in FIG. 4a, comprises an iron shell being able to be a sheet metal packet or a yoke, having grooves in which is placed a multi-phase winding comprising at least three sets of coils. A set of coils comprises at least one coil, each having an input 301 and an output 302. The coils of a same set of coils are connected in parallel. Each coil is electrically connected to a track 101 of an external connection member 200 via its input 301, by means of a connector 103 of the track 101. This configuration enables, thereafter, the putting in place of a triangle coupling or a star coupling.

According to an embodiment, each coil is electrically connected to the track 101 of the internal connection member 100 via its output 302, by means of a connector of the track 101 of the internal connection member 100. Thus, the three-phase electrical machine comprises a star coupling.

In this case, the track 101 of the internal connection member 100 is electrically connected to the stator 400.

In this case, the portion of cable composing the input 301 of each coil is parallel to the axis X, situated in the troughs 104, 105 wherein is electrically connected the corresponding connector 103. Thus, the electrical bulk is reduced.

The rotating electrical machine also comprises a rotor comprising an external diameter. In this case, the connectors 103 of the internal connection member 100 are situated at the exterior of the external diameter of the rotor. Thus, the rotor may be mounted by the two axial sides of the stator 400 enabling the rotor to be longer axially while overrunning and to be surrounded by the device 300.

According to another embodiment, the rotating electrical machine comprises a second three-phase electrical member and three external connection members 200 stacked axially between them are stacked on the device 300. It is then possible to realise, for example, a star coupling with six electrical phases.

According to another embodiment, not represented, it is obviously possible to inverse the external connection members into internal connection member and the internal connection member into external connection member. In this case, there are thus three internal connection members each comprising an output connector to be connected to a port of a rectifier inverter and the external connection member is connected to earth.

Moreover, it is possible, whether for a stator of a three-phase machine or a stator of a double three-phase machine, to arrange one or more internal or external connection members on the other axial side of the stator. Preferably, the connection member will be arranged having its track connected to the stator on one side and the three connection members on the other side. This makes it possible to reduce the axial bulk on one side of the stator and to have the three output connectors on the same side.

According to another embodiment, not represented, the stator may comprise three connection members each comprising identical undulated tracks, each of the connection members comprising external connectors and internal connectors electrically connected respectively in the external troughs and the internal troughs of their corresponding track.

The stator may thus have a triangle connection of the sets of coils. Each coil of the sets of coils comprises an output connected to an internal connector of a connection member and an input connected to an external connector of another connection member.

The device may establish an electrical connection with at least three sets of coils which makes it possible to be used within a rotating electrical machine. In the case of a three-phase stator, the stack of the three tracks of the internal connection members each forming an electrical phase of the rotating electrical machine.

The invention is not limited to the embodiments described previously with reference to the figures and alternatives could be envisaged without going beyond the scope of the invention.

What is claimed is:

1. An electrical connection device comprising:
an internal connection member surrounding an axis X comprising a track, an insulating shell covering at least one radial surface of the track and a plurality of connectors capable of conducting an electric current electrically connected to the track; and
a first external connection member surrounding the axis X and being stacked axially with the internal connection member, the first external connection member comprising a track, an insulating shell covering at least one radial surface of the track and a plurality of connectors electrically connected to the track;
wherein each track has an undulated shape forming troughs and peaks in the radial plane, the troughs comprising internal troughs situated opposite the axis X and external troughs situated on an external periphery of the track, each connector of the internal connection member being electrically connected in an internal trough of the track of the internal connection member and each connector of the first external connection member being electrically connected in an external trough of the track of the first external connection member.

2. The electrical connection device according to claim 1, wherein each track has an undulated ring shape.

3. The electrical connection device according to claim 1, wherein the tracks are identical.

4. The electrical connection device according to claim 1, further comprising:
a second external connection member surrounding the axis X and being stacked axially with the first external connection member;
a third external connection member surrounding the axis X and being stacked axially with the second external connection member.

5. The electrical connection device according to claim 4, wherein the external connection members are identical and angularly offset with respect to each other in such a way that each connector of an external connection member is situated axially opposite the external troughs exempt of connectors of the other external connection members.

6. The electrical connection device according to claim 4, wherein each external connection member comprises an output connector configured to be connected to an electrical equipment, for example a converter, and the external connection members are arranged one on the other with an angular offset in such a way that the output connectors are spaced apart by said angular offset.

7. A rotating electrical machine, comprising:
an electrical connection device according to claim 6;
a first three-phase electrical member comprising at least a first, a second and a third phase electrical input;
a stator provided with a multi-phase winding comprising at least a first, a second and a third set of coils, each set of coils comprising coils, each coil comprising an input and an output,
and in that the track of the first, second and third external connection members is electrically connected respectively to the first, second and third phase electrical input and in that the first, second, third sets of coils each comprise at least one corresponding coil having its input electrically connected respectively to the track of the first, second, third external connection member by means of a connector of the external connection member.

8. The rotating electrical machine according to claim 7, wherein the output of at least one coil of each set of coils is electrically connected to the track of the internal connection member by means of a connector of the internal connection member.

9. The rotating electrical machine according to claim 7, wherein the three-phase electrical member further comprises a converter fulfilling the function of rectifier-inverter, said converter comprising a first, a second and a third port, each respectively electrically connected to the track of the first, second and third external connection member by means respectively of the first, second and third phase input.

10. The rotating electrical machine according to claim 7, wherein each of the phase inputs is electrically connected to the corresponding track by means of the output connector of the corresponding external connection member.

11. The electrical connection device according to claim 2, wherein the tracks are identical.

12. The electrical connection device according to claim 2, further comprising:
a second external connection member surrounding the axis X and being stacked axially with the first external connection member;
a third external connection member surrounding the axis X and being stacked axially with the second external connection member.

13. The electrical connection device according to claim 3, further comprising:
a second external connection member surrounding the axis X and being stacked axially with the first external connection member;
a third external connection member surrounding the axis X and being stacked axially with the second external connection member.

14. The electrical connection device according to claim 5, wherein each external connection member comprises an output connector configured to be connected to an electrical equipment, for example a converter, and the external connection members are arranged one on the other with an angular offset in such a way that the output connectors are spaced apart by said angular offset.

15. The rotating electrical machine according to claim 8, wherein the three-phase electrical member further comprises a converter fulfilling the function of rectifier-inverter, said converter comprising a first, a second and a third port, each respectively electrically connected to the track of the first, second and third external connection member by means respectively of the first, second and third phase input.

16. The rotating electrical machine according to claim 8, wherein each of the phase inputs is electrically connected to the corresponding track by means of the output connector of the corresponding external connection member.

17. The rotating electrical machine according to claim 9, wherein each of the phase inputs is electrically connected to the corresponding track by means of the output connector of the corresponding external connection member.
